(19) United States
(12) Patent Application Publication
(10) Pub. No.: US 2013/0113742 A1
(43) Pub. Date: May 9, 2013

(54) VISUAL PRESENTATION METHOD AND APPARATUS FOR APPLICATION IN MOBILE TERMINAL

(71) Applicant: Samsung Electronics Co., Ltd., Gyeonggi-do (KR)

(72) Inventors: Young-Tae Jin, Gyeonggi-do (KR); Sung-Hwan Moon, Gyeonggi-do (KR); Yo-Ywang Im, Gyeonggi-do (KR); Yoon-Jeong Choi, Seoul (KR)

(73) Assignee: Samsung Electronics Co., Ltd., Gyeonggi-do (KR)

(21) Appl. No.: 13/667,781

(22) Filed: Nov. 2, 2012

(30) Foreign Application Priority Data
Nov. 9, 2011 (KR) 10-2011-0116460

(51) Int. Cl. G06F 3/048; G06F 3/041

(52) U.S. Cl. 345/173; 715/810; 715/803

(57) ABSTRACT

An apparatus performs a visual presentation method for an application in a mobile terminal. In the method, when switching of a first view mode is requested, a menu including at least one switchable view mode as an item is provided. A view mode is selected via the menu. A mode is switched to the selected view mode and an application is presented in the selected view mode.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 9, 2011 and assigned Serial No. 10-2011-0116460, the entire disclosure of which is hereby incorporated by reference.

### TECHNICAL FIELD OF THE INVENTION

The present disclosure relates to an application in a mobile terminal, and specifically a method and an apparatus for visual presentation in the mobile terminal.

### BACKGROUND OF THE INVENTION

Currently, due to development of electronic communication industries, an information communication apparatus such as a mobile communication terminal (cellular phone), an electronic scheduler, a Personal Digital Assistant (PDA), etc. has become a necessity of modem society, and serves as an important means for transferring rapidly changing information.

Conventional information communication apparatuses provide various services based on the Internet, for example, electronic mail, a remote computer connection, file transfer, Internet information search, Internet conversation and discussion, an electronic bulletin board, hypertext information viewing, and the like.

Recently, a web application, which is application software usable in a web browser via the Internet or an Intranet, is in the limelight. However, a way of showing the web application to a user (that is, visual presentation) is not diversified, so that the web application does not always draw the user's attention. Visual presentation is not diversified for general application as well.

### SUMMARY OF THE INVENTION

To address the above-discussed deficiencies of the prior art, it is a primary object to provide at least the advantages described below. Accordingly, an aspect of the present disclosure is to provide a method and an apparatus for providing various ways of showing an application to a user.

Another aspect of the present disclosure is to provide a method and an apparatus for easily switching a way of showing an application to a user.

In accordance with an aspect of the present disclosure, a visual presentation method for an application in a mobile terminal is provided. The method includes, when switching of a first view mode is requested, providing a menu comprising at least one switchable view mode as an item. The method also includes receiving from a user a selection of a view mode via the menu, and switching to the selected view mode and presenting an application in the selected view mode.

In accordance with another aspect of the present disclosure, a visual presentation apparatus for an application in a mobile terminal is provided. The apparatus includes an input unit configured to output an input signal, and an output unit configured to output a voice or an image corresponding to an output signal. The apparatus also includes a storage configured to store a program that controls an overall operation and various data input/output when a control operation is performed. The apparatus further includes a controller configured to control an overall operation, wherein when switching of a view mode is requested via the input unit, the controller is configured to output a menu comprising at least one switchable view mode as an item to the output unit, and when a view mode is selected in the menu via the input unit, the controller is configured to switch to the selected view mode and output an application to the output unit in the selected view mode.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mobile terminal according to an embodiment of the present disclosure;

FIG. 2 illustrates a visual presentation procedure for an application according to an embodiment of the present disclosure;

FIGS. 3A to 3E illustrate view modes according to an embodiment of the present disclosure; and

FIG. 4 illustrates an interface for switching a view mode for an application according to an embodiment of the present disclosure.

Throughout the drawings, like reference numerals will be understood to refer to like parts, components and structures.

### DETAILED DESCRIPTION OF THE INVENTION

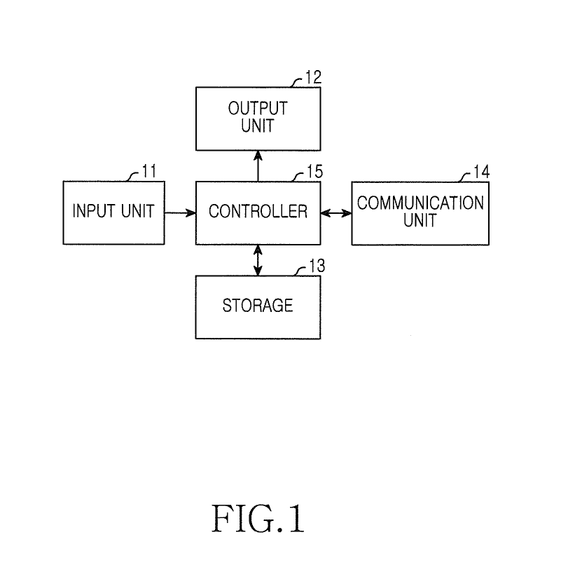

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

The present disclosure relates to an apparatus and a method for variously providing a way of showing an application to a user, that is, visual presentation.

Exemplary embodiments of the present disclosure provide a method and an apparatus for variously providing a way of showing an application to a user, that is, visual presentation. Exemplary embodiments of the present disclosure provide various view modes for visual presentation of an application. The view mode denotes a way of showing an application to a user so that the application matches with metaphors and functionalities used in a platform. The view mode according to an embodiment of the present disclosure includes a windowed view mode, a floating view mode, a full screen view mode, a maximized view mode, and a minimized view mode.

FIG. 1 is a block diagram illustrating a mobile terminal according to an embodiment of the present disclosure.

Referring to FIG. 1, the mobile terminal includes an input unit 11, an output unit 12, a storage 13, a communication unit 14, and a controller 15.

The input unit 11 outputs an input signal to the controller 15.

The output unit 12 receives an output signal and outputs the received output signal in the form of voice or an image under control of the controller 15.

A touch sensitive display, called as a touch screen, may be used as a unit which is integrated with the input unit 11 and the output unit 12. In this situation, a touch input may be performed via the touch sensitive display.

The mobile terminal may configure a touchscreen integrating the input unit 11 and the output unit 12.

The storage 13 stores a program for controlling an overall operation of the mobile terminal and various data input/output when a control operation of the mobile terminal is performed.

The communication unit 14 provides an environment that allows the mobile terminal to communicate with a web application server.

The controller 15 controls an overall operation of the mobile terminal. Hereinafter, a visual presentation method for an application by the controller 15 according to an embodiment of the present disclosure is described with reference to the drawing.

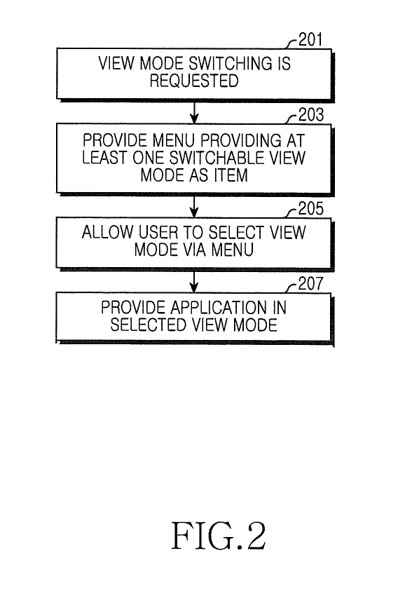

FIG. 2 is a flowchart illustrating a visual presentation procedure for an application according to an embodiment of the present disclosure.

Referring to FIG. 2, the controller 15 is requested to switch a view mode in block 201. For example, a user requests view mode switching by generating a touch event of a designated type such as a double tap, a long touch, etc.

The controller 15 provides a menu providing at least one switchable view mode as an item in block 203. For example, in a situation where an application is being provided in a windowed view mode, the menu may provide a floating view mode, a full screen view mode, a maximized view mode, and a minimized view mode as items.

The controller 15 allows the user to select a view mode via the menu in block 205. For example, the user touches a view mode to which the user desires to switch from the menu.

The controller 15 switches to the view mode selected in block 205 to provide an application in block 207.

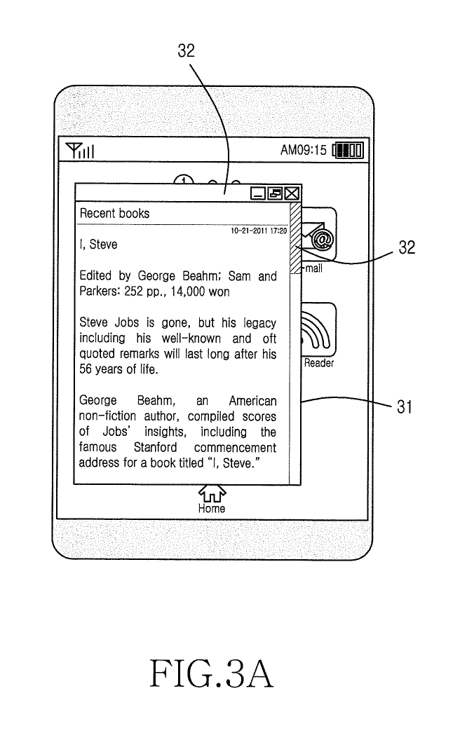

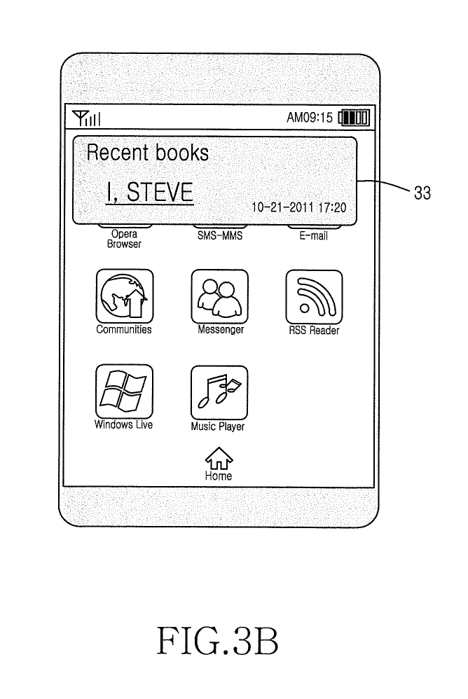

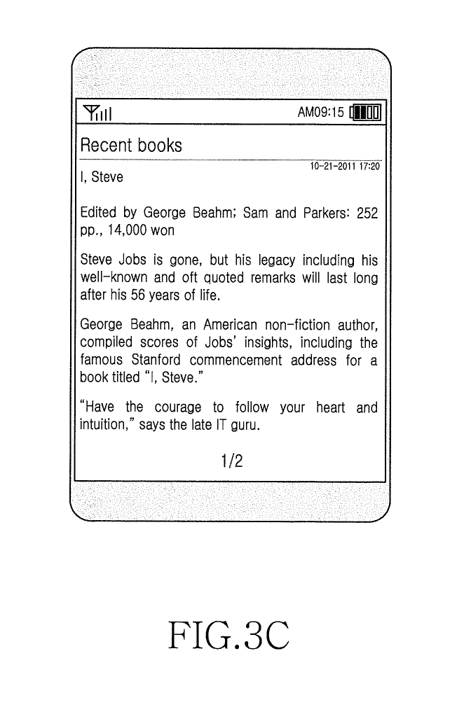

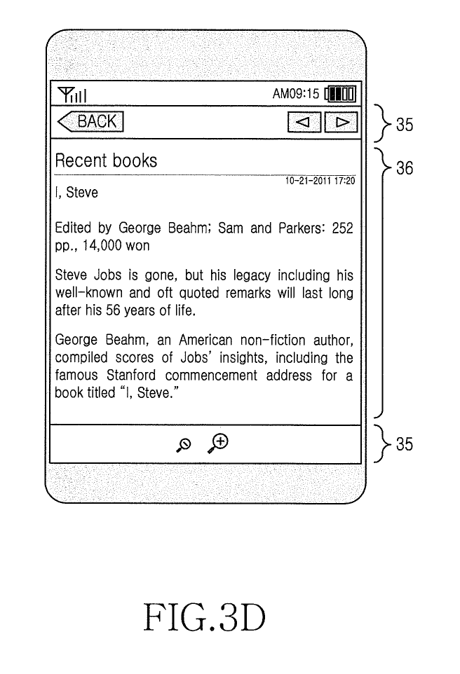

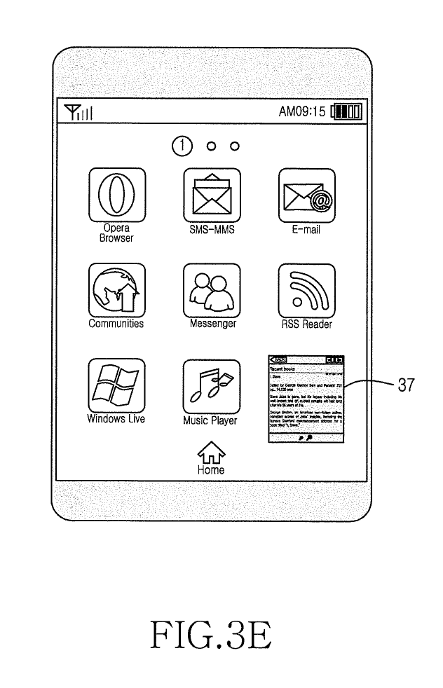

FIGS. 3A to 3E illustrate view modes according to an embodiment of the present disclosure.

FIG. 3A illustrates a windowed view mode 31 according to an embodiment of the present disclosure. The windowed view mode 31 configures a chrome 32, and provides an application in a windowed manner. Generally, a chrome denotes visual parts of a user agent that does not depend on contents, for example, a tool bar, a title bar, a menu, window decoration, and the like.

FIG. 3B illustrates a floating view mode according to an embodiment of the present disclosure. The floating view mode 33 does not configure a chrome but provides an immersive interface for an application in a windowed manner. The floating view mode 33 configures a view port. In a situation where the background of the view port is at least partially transparent, other system items, such as other applications, a background of a screen, etc., show through the view port. The immersive interface configures controls and components generated to match with a specific style of an application instead of a chrome of a platform and a widget. For example, the floating view mode may be a widget.

FIG. 3C illustrates a full screen mode according to an embodiment of the present disclosure. The full screen mode does not configure a chrome but provides an application on an entire screen.

FIG. 3D illustrates a maximized view mode according to an embodiment of the present disclosure. The maximized view mode configures a chrome 35 and provides an application on an entire screen region 36. The screen region 36 denotes a region on a screen for an application, and generally excludes a portion (ex: an upper bar representing a menu, time, a status, and a lower bar representing a list of applications that are being executed) occupied by the system.

FIG. 3E illustrates a minimized view mode according to an embodiment of the present disclosure. The minimized view mode 37 allows an application to perform docking with a shortcut icon or minimizes the application. The minimized view mode 37 does not hide an application completely but provides an icon dynamically representing content of the application. For example, the minimized view mode may be a thumbnail showing an entire page in a reduced size so that a user may review a layout of the entire page of the application.

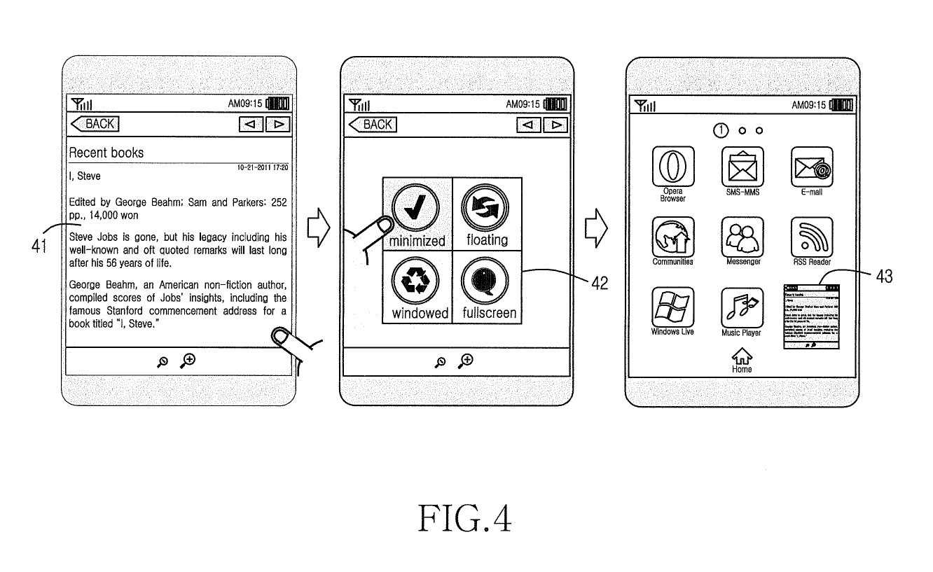

FIG. 4 illustrates an interface for switching a view mode for an application according to an embodiment of the present disclosure.

For example, the controller 15 provides an application in a maximized view mode 41. When a user double-taps a screen in order to switch a view mode, the controller 15 provides a menu 42 for providing the remaining view modes except the maximized view mode as items. That is, the controller 15 allows the user to select a view mode via the menu 42. When the user selects a minimized view mode, the controller 15 performs docking with a shortcut icon showing an entire page in a reduced small size and provides the application.

Consequently, a visual presentation method and an apparatus thereof for an application in a mobile terminal according to the present disclosure provide an application to a user in various manners, thereby drawing a user's attention.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

Although the disclosure has been shown and described with reference to certain exemplary embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A visual presentation method for an application in a mobile terminal, the method comprising:
when switching of a first view mode is requested, providing a menu comprising at least one switchable view mode as an item;
receiving from a user a selection of a view mode via the menu; and
switching to the selected view mode and presenting an application in the selected view mode.

2. The method of claim 1, wherein the at least one switchable view mode comprises a plurality of the following modes: a windowed view mode, a floating view mode, a full screen view mode, a maximized view mode, and a minimized view mode,
wherein the windowed view mode configures a chrome comprising visual parts of a user agent that does not depend on contents, and provides an application in a windowed manner that does not occupy an entire screen,
the floating view mode does not configure a chrome and provides an interface comprising controls and components that match with a specific style with respect to an application in a windowed manner,
the full screen view mode does not configure a chrome and provides an application over an entire screen,
the maximized view mode configures a chrome and provides an application over an entire screen region except a portion occupied by a system, and
the minimized view mode allows an application to perform docking with a shortcut icon or minimizes the application.

3. The method of claim 2, wherein the chrome comprises at least one of: a tool bar, a title bar, a menu, and window decoration.

4. The method of claim 2, wherein the first view mode and the at least one switchable view mode together comprise all of the following modes: the windowed view mode, the floating view mode, the full screen view mode, the maximized view mode, and the minimized view mode.

5. The method of claim 1, further comprising receiving the request to switch the first view mode based on a touch event by the user.

6. The method of claim 5, wherein the touch event is one of a double tap and a long touch.

7. The method of claim 1, wherein receiving from the user the selection of the view mode comprises receiving a touch event of an icon associated with the selected view mode in the menu.

8. A visual presentation apparatus for an application in a mobile terminal, the apparatus comprising:
an input unit configured to output an input signal;
an output unit configured to output a voice or an image corresponding to an output signal;
a storage configured to store a program that controls an overall operation and various data input/output when a control operation is performed; and
a controller configured to control an overall operation,
wherein when switching of a first view mode is requested via the input unit, the controller is configured to output a menu comprising at least one switchable view mode as an item to the output unit, and when a view mode is selected in the menu via the input unit, the controller is configured to switch to the selected view mode and output an application to the output unit in the selected view mode.

9. The apparatus of claim 8, wherein the at least one switchable view mode comprises a plurality of the following modes: a windowed view mode, a floating view mode, a full screen view mode, a maximized view mode, and a minimized view mode,
wherein the windowed view mode configures a chrome comprising visual parts of a user agent that does not depend on contents, and provides an application in a windowed manner that does not occupy an entire screen,
the floating view mode does not configure a chrome and provides an interface comprising controls and components that match with a specific style with respect to an application in a windowed manner,
the full screen view mode does not configure a chrome and provides an application over an entire screen,
the maximized view mode configures a chrome and provides an application over an entire screen region except a portion occupied by a system, and
the minimized view mode allows an application to perform docking with a shortcut icon or minimizes the application.

10. The apparatus of claim 9, wherein the chrome comprises at least one of: a tool bar, a title bar, a menu, and window decoration.

11. The apparatus of claim 9, wherein the first view mode and the at least one switchable view mode together comprise all of the following modes: the windowed view mode, the floating view mode, the full screen view mode, the maximized view mode, and the minimized view mode.

12. The apparatus of claim 8, wherein the controller is configured to receive the request to switch the first view mode based on a touch event by the user.

13. The apparatus of claim 12, wherein the touch event is one of a double tap and a long touch.

14. The apparatus of claim 8, wherein the input unit is configured to receive the selection of the view mode by receiving a touch event of an icon associated with the selected view mode in the menu.

15. A mobile terminal, comprising:
a touch screen comprising an input unit and an output unit;
a storage configured to store a program that controls an overall operation and various data input/output when a control operation is performed; and
a controller configured to control an overall operation,
wherein when switching of a first view mode is requested via the input unit, the controller is configured to output a menu comprising at least one switchable view mode as an item to the output unit, and when a view mode is selected in the menu via the input unit, the controller is configured to switch to the selected view mode and output an application to the output unit in the selected view mode.

16. The mobile terminal of claim 15, wherein the at least one switchable view mode comprises a plurality of the following modes: a windowed view mode, a floating view mode, a full screen view mode, a maximized view mode, and a minimized view mode,
wherein the windowed view mode configures a chrome comprising visual parts of a user agent that does not depend on contents, and provides an application in a windowed manner that does not occupy an entire screen,
the floating view mode does not configure a chrome and provides an interface comprising controls and components that match with a specific style with respect to an application in a windowed manner,
the full screen view mode does not configure a chrome and provides an application over an entire screen,
the maximized view mode configures a chrome and provides an application over an entire screen region except a portion occupied by a system, and
the minimized view mode allows an application to perform docking with a shortcut icon or minimizes the application.

17. The mobile terminal of claim 16, wherein the chrome comprises at least one of: a tool bar, a title bar, a menu, and window decoration.

18. The mobile terminal of claim 16, wherein the first view mode and the at least one switchable view mode together comprise all of the following modes: the windowed view mode, the floating view mode, the full screen view mode, the maximized view mode, and the minimized view mode.

19. The mobile terminal of claim 15, wherein the controller is configured to receive the request to switch the first view mode based on a touch event by the user.

20. The mobile terminal of claim 19, wherein the touch event is one of a double tap and a long touch.
